(19) United States
(12) Patent Application Publication
(10) Pub. No.: US 2003/0158622 A1
(43) Pub. Date: Aug. 21, 2003

(54) Multi-axes tool compensation: 3D and 5-axis real-time interactive tool compensation inside the CNC machine tool controller

(76) Inventor: Gary John Corey, Wildomar, CA (US)

Correspondence Address: Mr. Gary John Corey, 21445 Bundy Canyon Road, Wildomar, CA, 92595, US

(21) Appl. No.: 10/079,309

(22) Filed: Feb. 21, 2002

(51) Int. Cl. G06F 19/00

(52) U.S. Cl. 700/193; 700/192; 700/175

(57) ABSTRACT

Multi-Axes Tool Compensation expands the tool compensation methods available to the CNC machine operator from the 2D world to 3D and 5 axis directly inside the CNC Controller without involving the CNC programmer to re-define tool locations and offsets defined in the G code program. The CNC machine operator can insert and override any of the cutting methods or scenarios originally pre-defined in the G code program to add 3D and 5-axis tool offsets and tool shape characteristics. These algorithms also provide for automatic tool gouge avoidance protection. Tools are also re-located to safe positions when necessary. Multi-Axes Tool Compensation technology provides for 3D and 5-axis tool definitions and tools offsets accessible to the CNC machine operator.

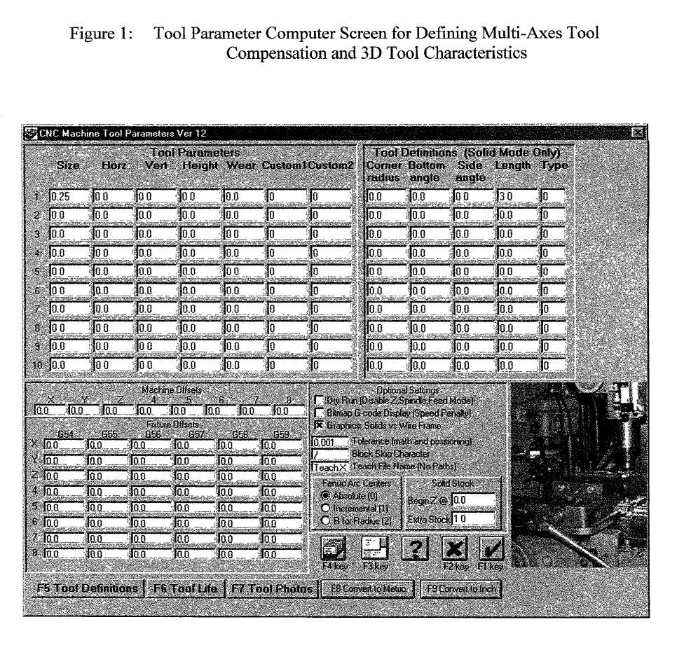

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A COMPUTER PROGRAM LISTING COMPACT DISK APPENDIX

The Appendix contains two copies on compact disk of the entire Multi-Axes Tool Compensation computer program listing in standard ASCII character file format. Each compact disk contains the same single file entitled MTC.TXT.

### BACKGROUND OF THE INVENTION

Multi-Axes Tool Compensation for 3D and 5-axis real-time interactive tool compensation relates to CNC machining techniques that are already in common practice for 2D tool compensation in CNC machining.

The applicable US patent Classification Definition to my invention is found in category 700 DATA PROCESSING: GENERIC CONTROL SYSTEMS OR SPECIFIC APPLICATIONS for Sub Class 1 GENERIC CONTROL SYSTEM, APPARATUS OR PROCESS.

Below are references to specific documents, articles and technical meetings related to my invention.

[1] STORI, J. A. and P. K. WRIGHT. A constant engagement offset for 2½D tool path generation. Proc. 1998 Intl. Mech. Engr. Congr. and Expo. (Anaheim, Calif., November 1998) MED-vol. 8, 475-481 (1998).

[2] DeVOR, R. E., S. G. KAPOOR, R. ZHU, K. JACOBUS, I. LAZOGLU, S. SASTRY, and M. VOGLER. Development of mechanistic models for the prediction of machining performance: Applications to process and product quality. Proc. CIRP Intl. Wkshp. on Modeling of Machining Oper. (Atlanta, Ga., May 1998) 407-416 (1998).

[3] FLORES, M. A. and T-C. TSAO. Supervisory machining control implementation using an open architecture CNC. Proc. Japan-USA Symp. on Flexible Automat. (Otsu, Japan, July 1998) 1157-1164 (1998).

[4] GAJJELA, R. R., S. G. KAPOOR, and R. E. DeVOR. A mechanistic force model for contour turning. 1998 Intl. Mech. Engr. Congr. and Expo. (Anaheim, Calif., November 1998) 8, 149-159 (1998).

[5] KAPOOR, S. G., R. E. DeVOR, R. ZHU, R. GAJJELA, G. PARAKKAL, and D. SMITHEY. Development of mechanistic models for the prediction of machining performance: model-building methodology. Proc. CIRP Intl. Wkshp. on Modeling of Machining Oper. (Atlanta, Ga., May 1998) 109-120 (1998).

[6] KUMAR, P. and P. M. FERREIRA. Hierarchical control of flexibly automated manufacturing systems. Proc. Japan-USA Symp. on Flex. Automat. (Otsu, Japan, July 1998) III, 1207-1214 (1998).

[7] K. KOTHARDARAMAN, KUMAR, P., and P. M. FERREIRA. Scalable, maximally-permissive deadlock avoidance for FMS. IEEE Conf. on Robotics and Automat. (Leuver, Belgium, May 1998).

Other References:

Pro/MFG Technical Meeting at the Omni Rosen Hotel, Orlando, Fla. Jun. 17, 2000 Compiled by Gene J Maes

Attendees:

Gene J Maes, Los Alamos National Laboratory,

Sam Moses, Caterpillar Inc.,

Marcus Vasquez, Solar Turbines,

Val Hubbard, Raytheon,

Jason Anderson, Adept Limited,

Bryan Garvin, Moen Inc.,

Brad Baas, Los Alamos National Laboratory,

Pete Lord, PTC,

Francois Lamy, PTC,

Charles Farah, PTC,

Gary Whalen, Harley-Davidson,

Tom Calenberg, MSC Technologies, Inc.,

Charles Wenning, Midmark Corp.,

Richard Bridy, ITT Goulds Pumps,

Johanna Rock, ITT Goulds Pumps,

Dan Schurr, Steelcase Inc.,

Brad Bush, kodak,

Chad Weber, John Deere,

Ron Johnson, United Defense,

Steve Wall, United Defense,

Randy Hoffman, Solar Turbines,

Norm Lamar, San Diego State University,

Jim Burns, San Diego State University,

Jeff Rowe, Honeywell,

Harold W. Kaiser, Walter Information Systems,

Anatol Borejdo, Walter Information Systems,

Presentations by:

Charles Farah

Norm Lamar& Jim Bums (San Diego State University)

Glenn Coleman

Francois Lamy

### BRIEF SUMMARY OF THE INVENTION

The object of Multi-Axes Tool Compensation is to provide CNC machinists using CNC controllers a convenient method for applying 3D and 5-axis tool compensation in real time directly within the CNC controller as they now enjoy when using the traditional 2D tool comp standards G41 and G42. Before my invention CNC controllers have not been technically advanced enough to employ multi-axes tool compensation methods. Using the technology methods of my invention for multi-axes tool compensation, the machine operator now has a pre-defined method to assign 3D and 5-axis tool characteristics at the CNC controller. CNC programmers and machinists now have the tools to issue 3D and 5-axis tool comp commands, which have not been available in traditional CNC controllers.

The CNC machine operator will no longer require the assistance of the CNC programmer to re-create a brand new CNC G code Program with new tool positions and definitions when a change is made. My invention allows the CNC machine operator to easily define the new tools using my complex 3D and 5-axis tool compensation algorithms built into the CNC Controller. These algorithms also provide for automatic tool gouge avoidance protection.

### DETAILED DESCRIPTION OF THE INVENTION

Multi-Axes Tool Compensation at the CNC controller provides CNC machinists using CNC Controllers a convenient method for applying 3D and 5-axis tool compensation in real time as they enjoy now when using the traditional 2D tool comp standards G41 and G42. Up until now CNC controllers have not been technically advanced enough to employ multi-axes tool compensation methods. Using these defined methods of my invention for multi-axes tool compensation, the machine operator now has a pre-defined method to assign 3D and 5-axis tool characteristics at the CNC controller. CNC programmers now have the tools to issue 3D and 5-axis tool comp commands, which have not been available in traditional CNC controllers. The CNC machine operator does not require the assistance of the CNC programmer to re-create a brand new CNC G code Program with new tool information and definitions when a change is made. My invention allows the CNC machine operator to define the new tools using complex 3D and 5-axis tool compensation algorithms built into the CNC controller. These algorithms also provide for automatic tool gouge avoidance protection.

Description of the Command Usage for Multi-Axes Tool Compensation

The TOOLCOMP command enables 3D and 5-axis tool compensation and has eight possible parameters: OFF, LEFT, RIGHT, 3DCOMP, 3DADJUSTZ, 3DOFFSET, 5AXIS and LLIMIT45. These parameters are usually associated with G40, G41, G42, G130, G131, G132 and G135. The compensation value is taken from the tool parameter screen for that specific tool number.

All tool compensation is preprocessed when the file is loaded into memory. If a tool size is changed or the user edits the G code program to reflect a change in tool comp methods, then the program will automatically reprocess and redraw the G code program. If 3D or 5-axis tool comp is used, the CAD/CAM system will need to include the special codes on each G code line that will need to be compensated. The special codes represent a normalized 3D vector and the L code represents a conical angle measured from the XYZ point to the nearest obstacle from a flat 2D plane. If the user specifies an angle after LLIMIT, then the tool position may be completely omitted in order to automatically avoid gouging. This occurs if the included angle between the vector and the L code is less than the value specified after LLIMIT. The default of LLIMIT is 45 degrees. To turn gouge protection off, specify a zero value after LLIMIT 0. Take caution if the tool size is increased at the control, which is larger than the original. An obstacle may exist beyond the diameter of the original tool size that may result in an unforeseen gouge. If the tool size is decreased from the original size, then there may be some extra stock left in tight comers since possible gouges were originally figured for a larger tool.

### EXAMPLES

| | |
|---|---|
| TOOLCOMP OFF | Turns all compensation off. |
| TOOLCOMP LEFT | ′Comps in 2D to the left. |
| TOOLCOMP RIGHT | ′Comps in 2D to the right. |
| TOOLCOMP 3DCOMP | ′3D comp based on vector and |
| | gouge parameter. |
| TOOLCOMP 3DADJUSTZ | ′3D comp lifts Z axis only but keeps X, Y. |
| TOOLCOMP 3DOFFSET | ′3D parallel offset only—based on vector |
| | and no ′gouge parameter. |
| TOOLCOMP 5AXIS | ′5 axis comp based on vector and |
| | gouge parameter. |
| TOOLCOMP LLIMIT45 | ′Give angle which will specify a gouge to |
| | omit tool ′position. |

What is claimed is:

1. Multi-Axes Tool Compensation technology handles all tool compensation internal to the CNC controller.

2. Multi-Axes Tool Compensation automatically does tool gouge avoidance protection internal to the CNC controller.

3. Multi-Axes Tool Compensation automatically contains algorithms to lift the tool to safe positions when necessary.

4. Multi-Axes Tool Compensation does not depend on the CNC programmer to re-define tool position coordinates when the tool characteristics change.

5. Multi-Axes Tool Compensation allows CNC machine operators to override the pre-defined tool characteristics.

6. Multi-Axes Tool Compensation has been in development and field use since 1991 by my customers.

7. I, Gary John Corey, solely invented Multi-Axes Tool Compensation technology based on research I conducted as a CNC machinist.

8. Multi-Axes Tool Compensation is unique because it expands the tool compensation methods available to the CNC machine operator from 2D to 3D and 5 axis directly on the CNC Controller without involving the CNC programmer to re-define tool locations and offsets defined in the G code program.
